(19) United States
(12) Patent Application Publication
(10) Pub. No.: US 2025/0297371 A1
(43) Pub. Date: Sep. 25, 2025

(54) COMPOSITIONS AND METHODS OF TREATING METAL SURFACES IN SURFACE PREPARATION PROCESSES

(71) Applicant: CHEMTREAT, INC., Glen Allen, VA (US)

(72) Inventors: James R. Lawson, Louisville, TN (US); William Henderson, Richmond, VA (US); Nicholas Seymour, Williamsburg, VA (US)

(73) Assignee: CHEMTREAT, INC., Glen Allen, VA (US)

(21) Appl. No.: 18/615,007

(22) Filed: Mar. 25, 2024

(51) Int. Cl. C23F 11/14; C09K 15/02; C09K 15/18; C09K 15/20

(52) U.S. Cl. CPC C23F 11/141; C09K 15/02; C09K 15/18; C09K 15/20

(57) ABSTRACT

A method for treating a metal surface in a surface preparation system. The method includes providing a treatment composition comprising amine borate, an organic corrosion inhibitor, and at least one surfactant, applying the treatment composition to a surface of the metal in the surface preparation system, and forming a protective anti-corrosion film on the surface of the metal.

### TECHNICAL FIELD

This application relates to compositions and methods for treating metal surfaces in surface preparation systems such as steel-making systems or cast iron smelting systems.

### BACKGROUND

In surface preparation systems, such as steel-making systems or cast iron smelting systems, metal surfaces need to be cleaned and prepared in order to prepare for downstream processing, shipment, and/or storage. In steel-making systems, for example, steel slabs are hot-rolled by forming and rolling the steel slabs into a long strip while heating above optimum rolling temperature. The hot-rolled slab is fed through a series of roll mills to form and stretch it into a thin strip. After forming is complete, the steel strip is water-cooled and wound into a coil. During the hot rolling process, a layer of oxide may form on the surface of the steel. This layer, or scale, is formed when iron in the steel reacts with oxygen in the air. Thickness and chemical composition of the scale is a function of the hot strip temperature and the availability of oxygen to the strip surface while it is hot.

Scaling is unacceptable for many end products and poses problems for downstream processes such as cold rolling, galvanizing, and/or coating and therefore must be removed. Conventional methods of scale removal use a chemical reduction technology or pickling, i.e., direct acid immersion or electrolytic acid immersion process. Hydrochloric acid (HCl) is usually used as a pickling agent. While acid pickling is effective in removing the scale, it involves an aggressive reaction that also roughens the surface of the steel strip and can even reduce strip thickness. Accordingly, an expensive inhibitor is typically added to the pickling solution to limit this reaction during slow line speed or line stop.

Most contemporary research has focused on alternative methods to chemically remove scale that do not involve the use of caustic acids. One such process is an acid-free cleaning process in which the steel strip is heated in a non-oxidizing atmosphere, and then guided through a high-temperature hydrogen atmosphere to chemically reduce the oxide compounds. But this process requires significant amounts of energy and has high operating costs.

Another process is slurry blasting that hydroblasts a slurry of iron particles to clean the steel surface by removing rust/scale. The slurry mixture is fed into a rotating impeller, which propels it at high velocity across the object to be cleaned. Cleaning agents can be introduced into a carrier liquid (e.g., water) to reduce smut and aid in rust prevention. The slurry may contain a corrosion inhibitor to passivate the metal surface and prevent corrosion. Often times conventional methodologies use phosphates. But phosphates create further challenges with working fluid stability.

### SUMMARY

Despite the progress afforded by slurry blasting methods, challenges remain. In this regard, steel-making systems are open systems, i.e., open to the environment. As a result, foaming and corrosion are significant problems. Therefore, there is still a need for better chemical treatments that are stable, low foaming, provide corrosion protection, and also provide the needed lubricity to allow the turbines to move the iron particle slurry. Lubricity of the system is also important in this context because it removes grit from the system. Corrosion inhibition is important because steel coils sit for up to 6 months and are exposed to oxidation. Product stability is directly related to the produced solids in a formulation. These produced solids are reflective of the measured turbidity and/or filterable material within a developed product. Products in their neat form that generate solids are generally considered unacceptable for use due to the fact that the solids coming out of solution represent intermediates that were intended for use in the given application.

The generation of solids, reflective of poor product/working solution stability, has other negative impacts. This includes but is not limited to the following: increased filter loading and water usage, increased potential for fouling and under deposit corrosion, decreased performance of the working fluid process, increased disposal costs, decreased heat transfer efficiency, and decreased lubricity.

These and other objects are addressed by the disclosed embodiments. Disclosed methods and compositions provide for superior performance properties including stability, foaming height and persistency, surface tension/lubricity, and corrosion inhibition. In this regard, the inventors have found that disclosed embodiments provide for better performance and allow the customer to run at a faster rate than conventional treatments by combining amine borate, an organic corrosion inhibitor, and a surfactant into treatment composition. An inorganic corrosion inhibitor may further be included.

In a first embodiment, there is provided a method for treating a metal surface in a surface preparation system. The method includes providing a treatment composition comprising amine borate, an organic corrosion inhibitor, and at least one surfactant, applying the treatment composition to a surface of the metal in the surface preparation system, and forming a protective anti-corrosion film on the surface of the metal.

In another embodiment, there is provided a method for treating a metal surface in a surface preparation system. The method includes providing a treatment composition comprising amine borate, an organic corrosion inhibitor, and at least one surfactant, applying the treatment composition to a surface of the metal in the surface preparation system, and forming a protective anti-corrosion film on the surface of the metal. The treatment composition can exclude phosphates, the organic corrosion inhibitor is at least one selected from the group consisting of TTA, BZT, HST, BuBZT, MBT, imidazoles, halogenated azoles and imidazolines, and amides, and the surfactant is an ethoxylate or propoxylate of a molecule which is not an alkylphenol.

In another embodiment, there is provided a treatment composition suitable to treat a metal surface in an industrial surface preparation process. The composition includes amine borate in an amount in a range of 1 to 60 wt %, an organic corrosion inhibitor in an amount in a range of 0.01 to 20 wt %, and at least one surfactant in an amount in a range of 0.01 to 20 wt %. The composition can exclude phosphates.

### BRIEF DESCRIPTION OF THE DRAWINGS

FIG. 1 is schematic illustration of a steel-making system according to an embodiment;

FIG. 2 is schematic illustration of slurry blasting cells according to an embodiment;

FIG. 3 is photograph illustrating results of a corrosion inhibition test according to an Example;

FIG. 4 is photograph illustrating results of a corrosion inhibition test according to an Example;

FIGS. 5A and 5B are photographs illustrating results of a corrosion inhibition test according to an Example (FIG. 5A) and a Comparative Example (FIG. 5B);

FIG. 6 is photograph illustrating results of a corrosion inhibition test according to comparative examples;

FIGS. 7A and 7B are photographs illustrating the results of a foam generation test for an example according to embodiments (FIG. 7A) and a comparative example (FIG. 7B);

FIGS. 8A and 8B are photographs illustrating the results of a foam cell generator test for an example according to embodiments (FIG. 8A) and a comparative example (FIG. 8B); and

FIGS. 9A and 9B are photographs illustrating the results of a turbidity test for an example according to embodiments (FIG. 9A) and a comparative example (FIG. 9B).

### DETAILED DESCRIPTION

### Overview

Embodiments apply the discovery of improved methods and compositions to industrial surface preparation systems including, but not limited to cast iron and steel preparation systems. Performance properties of improved foaming, corrosion inhibition, and surface tension can be achieved at lower cost and with less environmental impact by treating surface preparation systems with a synergistic mixture of amine borate, an organic corrosion inhibitor, and a surfactant. An inorganic corrosion inhibitor may further be included. Disclosed embodiments form an inhibitor film on the surface of corrodible metal by treatment with this mixture.

The disclosed embodiments provide a treatment composition including a surfactant that is stable with low turbidity unlike conventional compositions. Without intending to be bound by theory, it is believed that the stability of the disclosed compositions results from synergistic interaction of amine borate, the organic corrosion inhibitor, and the surfactant. Disclosed embodiments dilute the treatment composition with water to a specified concentration so that the working solution for the process remains free of solids. The disclosed treatment composition is effective without the need for conventional corrosion inhibitors that include phosphates.

### [System]

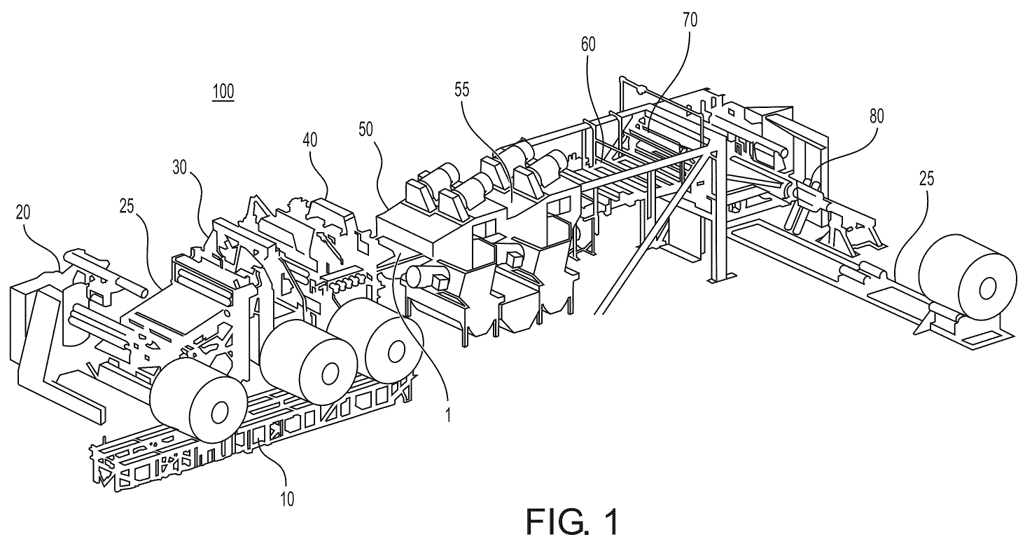

A surface preparation system 100 for processing a metal 1 according to embodiments is illustrated in FIG. 1. For purposes of this disclosure, the system 1 will be described with respect to a steel-making system and steel strip being processed in that system. However, it will be understood that the surface preparation system 100 may be any industrial metal processing or preparation system. For example, the metal may be cast iron and the system may be a cast iron smelting system.

System 100 may include a coil staging/loading module 10, uncoiler 20 with a peeler table 25, crop shear 30, roller-leveler 40 configured to flatten a steel material and remove a coil set, one or more slurry blasting cells 50, 55, drying table 60 configured to supply high-velocity air knives, electrostatic oiler 70, recoiler 80, and coil off-loading and banding station 90 for processing the steel strip 1. The system 100 may also include a slurry reservoir/separator/filter (not shown). The system 100 may be a closed-loop system.

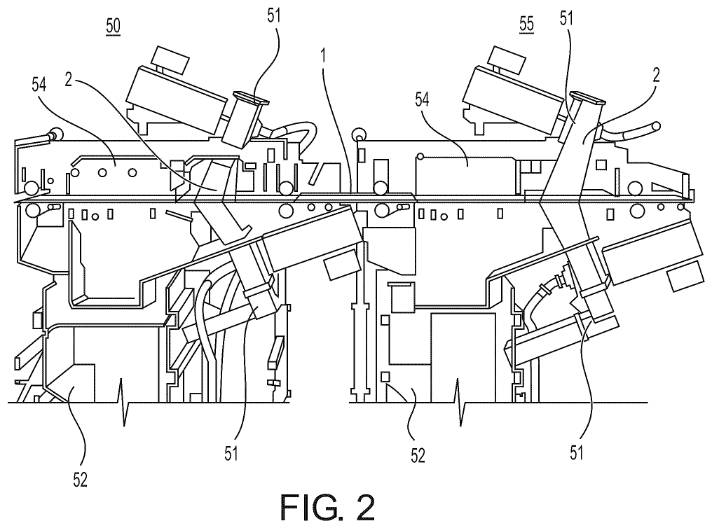

As seen in FIG. 2, each slurry blasting cell 50, 55 includes a pump(s) or turbine(s) 51 for propelling a mixture of water and grit to the metal surface. The grit may include carbon steel grit with irregular shape. The irregular shape increases the effectiveness of the de-scaling.

Downstream of the pump(s) or turbine(s) 51 are nozzles 54 for dispensing water for cleaning the surface of the treated steel strip 1. Water, grit, and surface deposits removed from the steel strip 1 is collected in the sumps 52 and recirculated back through the system. In embodiments, the surface deposits may be iron oxides.

### [Methods of Treatment]

Disclosed methods include treating the metal 1 in the surface preparation system 100. The method includes providing the treatment composition comprising the amine borate, organic corrosion inhibitor, and surfactant disclosed herein. The method includes applying the treatment composition to a surface of the metal in the surface preparation system. The treatment composition 2 may be applied onto at least one of the upper and lower surfaces of the steel strip 1 through the pump(s) or turbine(s) 51, i.e., as part of the mixture of water and steel grit, or via the nozzles 54, i.e., as a separate composition from the mixture of water and grit.

This applying step may include spraying the treatment composition on the surface of the metal via nozzles 54. The applying step may also include injecting or infusing the treatment composition into any suitable location in the cells 50, 55, as would be understood by one of ordinary skill in the art. The treatment composition may be applied in or from any suitable direction so to reach any portion of the metal in the system. The method may include, as a result of the application of the treatment composition, forming a protective anti-corrosion film on the surface of the metal.

The method may further include performing a de-scaling and cleaning process on the surface of the metal before or during applying the treatment composition to the surface of the metal in the surface preparation system. The method may further include performing a finishing process on the metal after forming the protective anti-corrosion film on the surface of the metal.

In preferred embodiments, the de-scaling and cleaning process on the surface of the metal before occurs before application of the treatment composition to the surface of the metal in the surface preparation system so that the treatment operates on a clean and de-scaled surface for enhanced effect. The de-scaling removes contaminates and other debris from the surface of the metal. The contaminates may include, for example, iron oxides.

The de-scaling and cleaning process may include applying a mixture of water and steel grit to the metal surface. In embodiments, the de-scaling and cleaning process may include an eco-pickling process that excludes acid pickling. The de-scaling and cleaning process may include applying a solution to the metal surface, and the solution may have a pH higher than 2.5. The de-scaling and cleaning process may exclude applying an aqueous solution to the metal surface. The de-scaling and cleaning process may include using at least one of wire brushes, scraping, polishing, dry-blasting, hydro-blasting, slurry-blasting, and alkali descaling.

### [Treatment Composition]

Disclosed treatment compositions effectively get more corrosion inhibitor into the surface processing system and onto functional surfaces than conventional treatments, where active ingredients tend to remain in the treatment composition. Conventional treatments also require significant amounts of anti-foaming agents to control foaming, e.g., 5-7 gallons per day.

In embodiments, the treatment composition may be a mixture of amine borate, an organic corrosion inhibitor, and one or more surfactants. Amine borate functions as a corrosion inhibitor in metal working processes. An inorganic corrosion inhibitor may further be included. Without intending to be bound by theory, it is believed that amine borate creates a stable protective film on metal surfaces that inhibits corrosion. The inventors found that amine borate, an organic corrosion inhibitor, and one or more surfactants, creates synergistic corrosion inhibition without the need for conventional inorganic corrosion inhibitors such as phosphates.

The organic corrosion inhibitor may be an unsaturated carboxylic acid polymer such as polyacrylic acid, homo or co-polymaleic acid (synthesized from solvent and aqueous routes); acrylate/2-acrylamido-2-methylpropane sulfonic acid (AMPS) copolymers, acrylate/acrylamide copolymers, acrylate homopolymers, terpolymers of carboxylate/sulfonate/maleate, terpolymers of acrylic acid/AMPS, phosphonates and phosphinates such as 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO), amines such as N,N-diethylhydroxylamine (DEHA), diethyl amino ethanol (DEAE), dimethylethanolamine (DMAE), cyclohexylamine, morpholine, monoethanolamine (MEA), azoles such as tolyltriazole (TTA), benzotriazole (BZT), methylbenzotriazole (MBT), butylbenzotriazole (BuBZT), halogen-stable azole (HST), halogenated azoles, and their salts.

In embodiments, the organic corrosion inhibitor is selected from TTA, BZT, HST, BuBZT, MBT, imidazoles, halogenated azoles and imidazolines, amides, sodium salts, or mixtures thereof. In preferred embodiments, the organic corrosion inhibitor may be TTA.

The surfactant may be any suitable surfactant that exhibits stability in the disclosed methods and formulations. The surfactant may be an ionic surfactant or a non-ionic surfactant. For example, the surfactant may be, but is not limited to, any one or more of the following: linear alkylbenzene sulfonate, sodium lauryl sulfoacetate, disodium lauryl sulfosuccinate, sodium dioctyl sulfosuccinate, alkyl polyglycoside, sodium dodecylbenzene sulfonate, nonionic polyoxyethylene, polyoxypropylene block copolymer, ethoxylated alkyl phenol nonionic surfactant, glucoside, terpene-based proprietary dispersant, ethylene oxide/propylene oxide (EO/PO) block copolymer, ethylene oxide/propylene oxide (EO/PO) alcohols, polyoxyethylene ether, sodium dodecyl diphenyloxide disulfonate and mixtures thereof.

In embodiments, the surfactant may be an ethoxylate or propoxylate of a molecule which is not an alkylphenol, a compound containing an ethoxy group and a propoxy group, or an alkoxylated saturated alcohol. Preferably, the surfactant is an alkyl polyglycoside or ethylene oxide/propylene oxide alcohol. In embodiments, the treatment composition may include two surfactants. In preferred embodiments, the treatment composition may include ethylene oxide/propylene oxide block copolymer and ethoxylated propoxylated alcohol. The inventors have found that these surfactants result in particularly unexpected stability of the treatment composition.

The treatment composition may also include an inorganic corrosion inhibitor. The inorganic corrosion inhibitor may be a salt of one or more of Sn, Zn, Mo, W, Ce, La, and Al. In preferred embodiments, the inorganic corrosion inhibitor is a stannous (Sn) salt. Stannous corrosion inhibitors particularly suitable for use with the disclosed methods include Tin (II) compounds. Tin (II) is more soluble in aqueous solutions than a higher oxidation state metal ion, such as Tin (IV). The corrosion inhibitor may be provided as a stannous salt selected from the group consisting of stannous sulfate, stannous bromide, stannous chloride, stannous oxide, stannous phosphate, stannous pyrophosphate, and stannous tetrafluroborate.

In embodiments, the treatment composition may be a liquid or solid formulation. A concentration of the treatment composition in the formulation may be in a range of 1% to 40%, 1% to 30%, 1% to 25%, 1% to 10%, 3% to 25%, 3% to 20%, 3.5% to 4.5, or preferably 3.75% to 4.25% or about 4%. In liquid form, the treatment composition may include in a range of 60% to 90%, 70% to 80%, or 75% to 80% water.

In embodiments, a concentration of the amine borate in the treatment composition neat may be in the range of 1 to 60 wt %, 1 to 40 wt %, 5 to 30 wt %, 10 to 20 wt %, or 10 to 18 wt %. A concentration of the organic corrosion inhibitor in the treatment composition neat may be in the range of 0.01 to 20 wt %, 0.01 to 10 wt %, 0.01 to 5 wt %, 0.07 to 1.8 wt %, or 1.2 to 1.8 wt %. A concentration of the surfactant in the treatment composition neat may be in the range of 0.01 to 20 wt %, 0.1 to 10 wt %, 0.25 to 10 wt %, 1 to 10 wt %, or 1 to 5 wt %. A concentration of the inorganic corrosion inhibitor in the treatment composition neat may be in the range of 0.01 to 10 wt %, 0.1 to 5 wt %, 0.1 to 5 wt %, 0.4 to 2 wt %, or 0.6 to 1 wt %.

In embodiments, a concentration of the amine borate in the treatment composition in aqueous solution may be in the range of 1 to 10,000 ppm, 100 to 10,000 ppm, 500 to 10,000 ppm, 1,000 to 9,000 ppm, 3,000 to 7,500 ppm, or 5,000 to 7,200 ppm. A concentration of the organic corrosion inhibitor in the treatment composition in aqueous solution may be in the range of 1 to 1,000 ppm, 10 to 700 ppm, 100 to 500 ppm, or 240 to 360 ppm. A concentration of the surfactant in the treatment composition in aqueous solution may be in the range of 1 to 1,000 ppm, 10 to 700 ppm, 100 to 500 ppm, or 200 to 400 ppm. A concentration of the inorganic corrosion inhibitor in the treatment composition in aqueous solution may be in the range of 1 to 1,000 ppm, 1 to 500 ppm, 10 to 250 ppm, or 50 to 120 ppm.

In embodiments, a ratio of a concentration of the amine borate to the organic corrosion inhibitor in the treatment composition in terms of ppm may be in the range of 0.01 to 100, 1 to 50, 1 to 20, or 10 to 20. A ratio of a concentration of the amine borate to the total amount of surfactant in the treatment composition in terms of ppm may be in the range of 0.01 to 100, 1 to 50, 1 to 20, or 10 to 20. A ratio of a concentration of the organic corrosion inhibitor to the total amount of surfactant in the treatment composition in terms of ppm may be in the range of 0.01 to 100, 0.1 to 10, or 0.75 to 1.25. A ratio of a concentration of a total amount of the amine borate and the organic corrosion inhibitor to the total amount of surfactant to in terms of ppm may be in the range of 1 to 1000, 1 to 500, 1 to 200, or 10 to 200.

In embodiments, the chloride levels in the treatment composition may be reduced compared to conventional formulations having up to 36,000 ppm chloride as a neat product, and 144 ppm chloride in a 4% solution (in water). For example, chloride levels according to embodiments may be in a range of 0 to 1,000 ppm, 0.01 to 800 ppm, 0.1 to 500 ppm, or 1 to 250 ppm for neat, and/or 0.01 to 100 ppm, 0.01 to 75 ppm, 0.1 to 50 ppm, 1 to 30 ppm, or 1 to 15 ppm for 4% solution (in water).

In embodiments, the sulfate levels in the treatment composition may be reduced compared to conventional formulations having up to 36,000 ppm sulfate as a neat product, and 144 ppm sulfate in a 4% solution (in water). For example, sulfate levels according to embodiments may be in a range of 0 to 1,000 ppm, 0.01 to 800 ppm, 0.1 to 500 ppm, or 1 to 250 ppm for neat, and/or 0.01 to 100 ppm, 0.01 to 75 ppm, 0.1 to 50 ppm, 1 to 30 ppm, or 1 to 15 ppm for 4% solution (in water).

Disclosed treatment compositions also utilize far less anti-foaming agent than conventional treatments. In this regard, disclosed treatment compositions may require no supplemental anti-foaming agent, or in a range of 0 to 4 gallons per day, 0.1 to 3 gallons per day, 0.5 to 2 gallons per day, or 0.75 to 1.5 gallons per day.

The concentrations of the amine borate, organic corrosion inhibitor, and surfactant achieved during treatment may be selected to meet or exceed as surface demand of the metal or a baseline system demand of the system and thereby ensure that a portion of the composition is available to treat the metal surfaces.

### EXAMPLES

The following experiments examine Examples according to disclosed embodiments compared to Comparative Examples across various metrics, including surface tension, corrosion, and foaming performance. The metrics were measured as follows except where otherwise noted:
Cast iron chip (CIC) corrosion testing was conducted according to ASTM D4627;
Foam generation was conducted according to a modified ASTM D3519 method. Foam generation testing was conducted by pouring a 250 ml sample into a 500 mL graduated cylinder, switching on the main pump and allowing water to recirculate for 1 minute, or until foam height reached the top of the cylinder (whichever is first), and then turning off the pump and measuring the foam height using a ruler from the top of the foam to the meniscus; and
Foam height testing was also conducted according to a modified ASTM D3519 method. Foam height testing was conducted by preparing the aqueous solution mixture at the desired concentration using RO water to dilute, testing at temperature was desired, and the aqueous solution was placed into 500 mL containers and placed in a hot water bath at 29.4° C./85° F., after letting the samples sit until they came to temperature, they were checked with a thermometer, 500 mLs was added to a ninja blender, as soon as sample was placed in the blender, the lid was placed on and the sample was mixed on “high” for 1 minute, after 1 minute, the sample was poured into a 1 L graduated cylinder and a timer started, foam height was measured (in mm) with a ruler from the top of the foam to the meniscus of the solution in the graduated cylinder, and foam height. Measurements were recorded every 15 seconds for the first minute, and then at 2.5 minutes and 5 minutes.

Example 1 is a composition having the following formulation:
18% Amine Borate-7200 ppm in 4%
1.8% triazole-360 ppm in a 4%
1.0% L62 (Ethylene Oxide/Propylene Oxide Block Copolymers) (100% active)
0.25% Ethox 1437 (Ethoxylated propoxylated alcohol) (100% active)
0.6% Stannous Chloride

Example 2 is a composition having the following formulation:
18% Amine Borate-7200 ppm in 4%
1.8% triazole-360 ppm in a 4%
1.0% L62 (Ethylene Oxide/Propylene Oxide Block Copolymers) (100% active)
0.25% Ethox 1437 (Ethoxylated propoxylated alcohol) (100% active)

Example 3 is a composition having the following formulation:
18% amine borate-7200 ppm in 4%
1.2% triazole-240 ppm in 4%
10% NP9-4000 ppm in a 4%
0.4% Stannous Chloride-80 ppm in 4%

Example 4 is a composition having the following formulation:
18% amine borate-7200 ppm in 4%
1.8% triazole-360 ppm in a 4%
10% NP9-4000 ppm in a 4%
0.6% Stannous Chloride-120 ppm in a 4%

Example 5 is a composition having the following formulation:
18% Amine Borate (100% active)-7200 ppm in 4%
0.07% triazole (50% active)-14 ppm in a 4%
10% NP9 (Alkylphenol Ethoxylate (APE)) (100% active)-4000 ppm in a 4%
0.1% Stannous Chloride (50% active)-20 ppm in a 4%

Comparative Example 1 is a 4% dispersion of a conventional amine borate lubricant that includes a phosphate.

### Experiment I

Samples of Example 1 were subjected to CIC corrosion testing according to the following dosages listed in Table 1 below.

TABLE 1
Samples of Example 1

| Sample No. | Dosage |
|---|---|
| S1A | 0.5% |
| S1B | 1.0% |
| S1C | 1.5% |
| S1D | 2.0% |
| S1E | 2.5% |
| S1F | 3.0% |
| S1G | 4.0% |
| S1H | 5.0% |

Samples of Example 2 were subjected to CIC corrosion testing according to the following dosages listed in Table 2 below.

TABLE 2
Samples of Example 2

| Sample No. | Dosage |
|---|---|
| S2A | 0.0% |
| S2B | 0.5% |
| S2C | 1.0% |
| S2D | 1.5% |
| S2E | 2.0% |
| S2F | 2.5% |
| S2G | 3.0% |
| S2H | 4.0% |
| S2I | 5.0% |
| S2J | 7.0% |
| S2K | 10.0% |

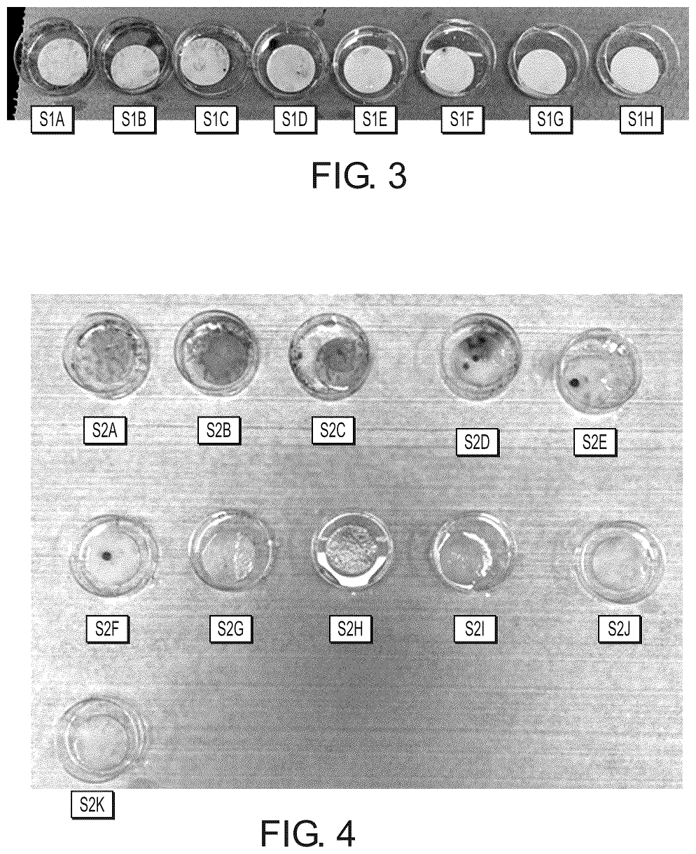

The results are illustrated in FIG. 3 (Example 1) and FIG. 4 (Example 2). As seen in the FIGS. 3 and 4, Example 1 exhibited a comparable corrosion inhibition profile compared to Example 2. In particular, Examples 1 and 2 had a breakpoint of about 2-2.5% indicating no loss in corrosion inhibition with the formulation excluding stannous chloride (Example 2). It should be noted that the in Sample SIF of Example 1 (3%) there was a single chip that was not fully coated with the solution. As a result, Sample SIF shows a corrosion spot in FIG. 3. This sample is not considered a failure of the disclosed methods, i.e., if it were, Sample S1E (2.5%) should also have a spot on it but it does not, as seen in FIG. 3.

### Experiment II

Samples of Example 3 were subjected to CIC corrosion testing according to the following dosages listed in Table 3 below.

TABLE 3
Samples of Example 3

| Sample No. | Dosage |
|---|---|
| S3A | 2.0% |
| S3B | 2.5% |
| S3C | 3.0% |

Samples of Example 4 were subjected to CIC corrosion testing according to the following dosages listed in Table 4 below.

TABLE 4
Samples of Example 4

| Sample No. | Dosage |
|---|---|
| S4A | 0.5% |
| S4B | 1.0% |
| S4C | 1.5% |
| S4D | 2.0% |
| S4F | 2.5% |
| S4F | 3.0% |
| S4G | 4.0% |
| S4H | 5.0% |
| S4I | 7.0% |
| S4J | 10.0% |

Samples of Comparative Example 1 were subjected to CIC corrosion testing according to the following dosages listed in Table 4 below.

TABLE 4
Samples of Comparative Example 1

| Sample No. | Dosage |
|---|---|
| S6A | 0.5% |
| S6B | 1.0% |
| S6C | 1.5% |
| S6D | 2.0% |
| S6E | 2.5% |
| S6F | 3.0% |
| S6G | 4.0% |
| S6H | 5.0% |
| S6I | 7.0% |
| S6J | 10.0% |

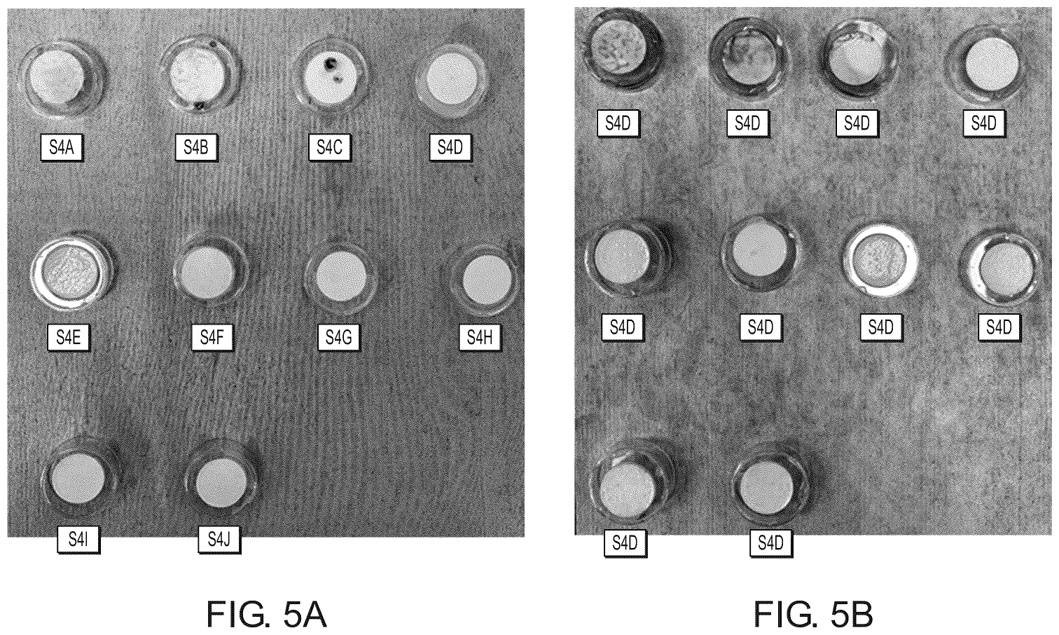

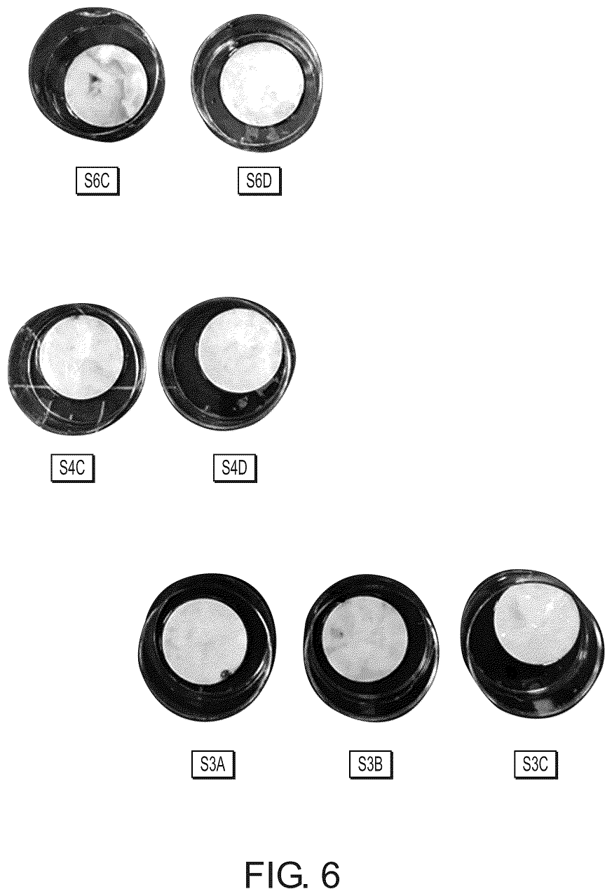

Corrosion for Examples 3 and 4 and Comparative Example 1 were comparable in CIC corrosion testing, as shown in FIGS. 5A, 5B, and 6. As seen in FIGS. 5A and 5B, Example 4 (FIG. 5A) CIC corrosion showed a breakpoint of 2-2.5%, comparable with Comparative Example 1 (FIG. 5B). As seen in FIG. 6, Example 3 CIC testing was comparable to Example 4.

### Experiment III

Example 5 and Comparative Example 1 were tested for surface tension, corrosion, and foaming performance. The results are illustrated in Tables 5-8 below.

TABLE 5
4% Comparative Example 1 solution turbidity test, with 2500
ppm Cloud point anti-foaming product addition and filtration

| Turbidity | | NTU |
|---|---|---|
| at 95F | NTU | after filter |
| Untreated | 650 | 400 |
| 2500 ppm Cloud Point | 901 | 367 |

TABLE 6
Comparative Example 1 and Comparative Example 1 with
2500 ppm cloud point foam height test at 98° F.

| Foam | | | | |
|---|---|---|---|---|
| Height | | | | |
| Test | Initial | 30 sec | 45 sec | 1 minute |
| Comparative Example 1 | 55 mm | 54 mm | 53 mm | 53 mm |
| only | | | | |
| Comparative Example 1 + | 53 mm | 52 mm | 52 mm | 52 mm |
| 2500 ppm Cloud Point | | | | |
| Comparative Example 1 + | 52 mm | 52 mm | 52 mm | 52 mm |
| 2500 ppm Cloud Point | | | | |
| through filter cloth | | | | |

TABLE 7
Comparative Example 1 and Comparative Example 1 with
2500 ppm cloud point foam height test at 78° F.

| Foam | | | |
|---|---|---|---|
| Height | | | |
| Test | Initial | 30 sec | 1 minute |
| Comparative Example 1 | 73 mm | 70 mm | 65 mm |
| only | | | |
| Comparative Example 1 + | 53 mm | 52 mm | 52 mm |
| 2500 ppm Cloud Point | | | |
| Comparative Example 1 + | 54 mm | 54 mm | 53 mm |
| 2500 ppm Cloud Point through filter | | | |
| cloth | | | |

TABLE 8
Comparative Example 1 and Comparative Example 1 with
2500 ppm cloud point surface tension test at 98° F.

| Sample | 25 mS | 250 mS | | 1000 mS |
|---|---|---|---|---|
| Comparative Example 1 | 36.6 mm | 33.2 | mm | 32.4 mm |
| only | | | | |
| Comparative Example 1 + | 33.1 mm | 31 | mm | 30.7 mm |
| 2500 ppm Cloud Point | | | | |
| Comparative Example 1 + | 35.4 mm | 31.9 | mm | 31.6 mm |
| 2500 ppm Cloud Point | | | | |
| through filter cloth | | | | |
| Example 5 | 47.4 mm | 31.9 | mm | 30.5 mm |
| Example 1 | 45.3 mm | 31.5 | mm | 30.3 mm |

Foam testing was conducted by placing 50 mL of Example 5 sample into a 100 mL graduated cylinder. The cylinder was then shaken and the foam height recorded in mm over time. This test method was done as a quick comparison for foam efficacy between filtered and unfiltered.

### Experiment IV

Experiments showed that foam generation associated with Example 5 only required enhancements to the testing protocol but a change in the surfactant package associated with foam generation and lubricity. New formulations according to embodiments match or exceed the properties associated with foam height, foam persistency, surface tension/lubricity and corrosion inhibition when compared to Comparative Example 1 utilizing a 4% dosage.

In a blender test, 500 mL of 4% solutions were added to the blender and mixed on high for 1 minute, before being poured off into a 1 L graduated cylinder and foam height measured over time. In a foam cell generator test, 500 mL of 4% solutions Example 1, Example 5, and Comparative Example 1 were heated before being added, with 250 mL being added to the device. The foam cell generator creates foam by circulating the solution and pushing air through a sparging tube. The foam cell generator was run at 100% recirculation for 30 seconds and then foam height was measured over time. All testing was performed at 35° C. The results are illustrated in Tables 9-13 below.

### Surface Tension

TABLE 9
Surface tension results at 35° C.

| dynes/cm | 25 ms | 250 ms | 1000 ms |
|---|---|---|---|
| Comparative Example 1 (4%) | 40.8 | 36.8 | 35.5 |
| Example 1 (4%) | 44.4 | 34.8 | 32.7 |
| Example 5 (4%) | 45.3 | 31.5 | 30.3 |

### Foam Generation: High Speed Blender Method

TABLE 10
Foam height

| | Foam |
|---|---|
| Example | height |
| 1 | (mm) |

| | | |
|---|---|---|
| 15 | s | 4 |
| 30 | s | 4 |
| 45 | s | 4 |
| 60 | s | 5 |
| 2.5 | min | 6 |
| 5 | min | 6 |

TABLE 11
Foam height

| Comparative | Foam |
|---|---|
| Example | height |
| 1 | (mm) |

| | | |
|---|---|---|
| 15 | s | 7 |
| 30 | s | 8 |
| 45 | s | 9 |
| 60 | s | 9 |
| 2.5 | min | 9 |
| 5 | min | 10 |

TABLE 12
High Shear Foam Cell Generator
Foam height

| | Foam |
|---|---|
| Example | height |
| 1 | (mm) |

| | | |
|---|---|---|
| 15 | s | 24 |
| 30 | s | 18 |
| 45 | s | 17 |
| 60 | s | 16 |
| 2.5 | min | 15 |
| 5 | min | 14 |

TABLE 13
Foam height

| | |
|---|---|
| | Foam |
| Comparative | height |
| Example 1 | (mm) |

| | | |
|---|---|---|
| 15 | s | 134 |
| 30 | s | — |
| 45 | s | 120 |
| 60 | s | 107 |
| 2.5 | min | 54 |
| 5 | min | 24 |

Example 1 fully passed corrosion testing for the 4% dosage. Surface tension/lubricity was maintained with Example 1 and surface tension results are as shown in Table 9. Surface tension values are correlated to lubricity and taken using a bubble point tensiometer. Example 1 delivered almost identical values, or slightly improved, when compared to Comparative Example 1 and similar values to Example 5.

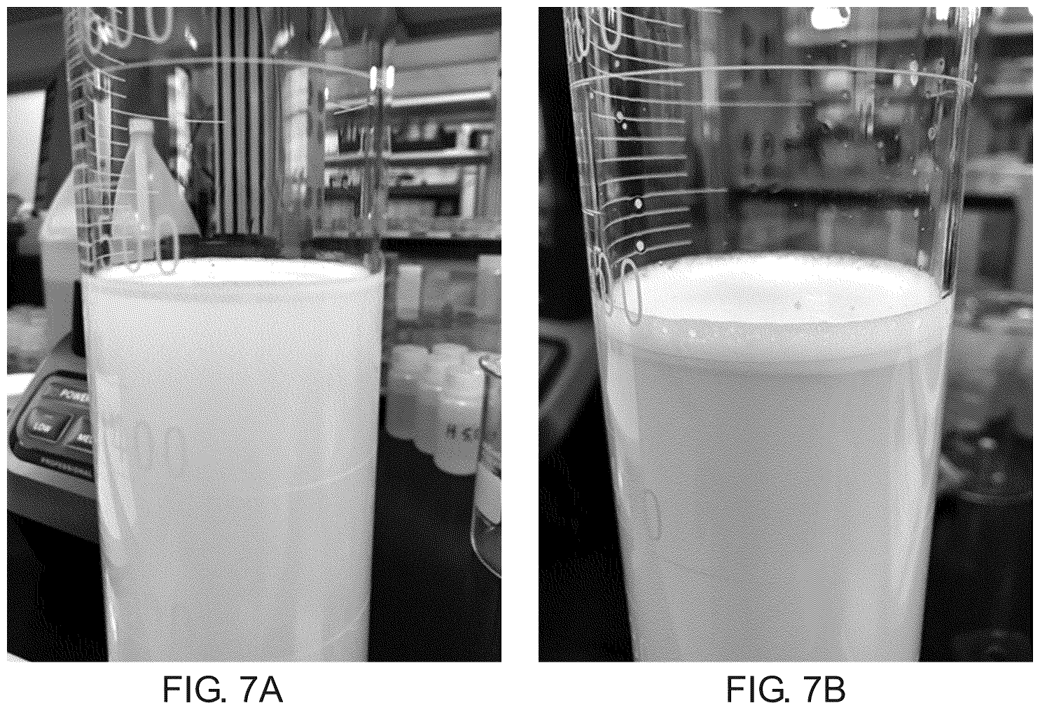

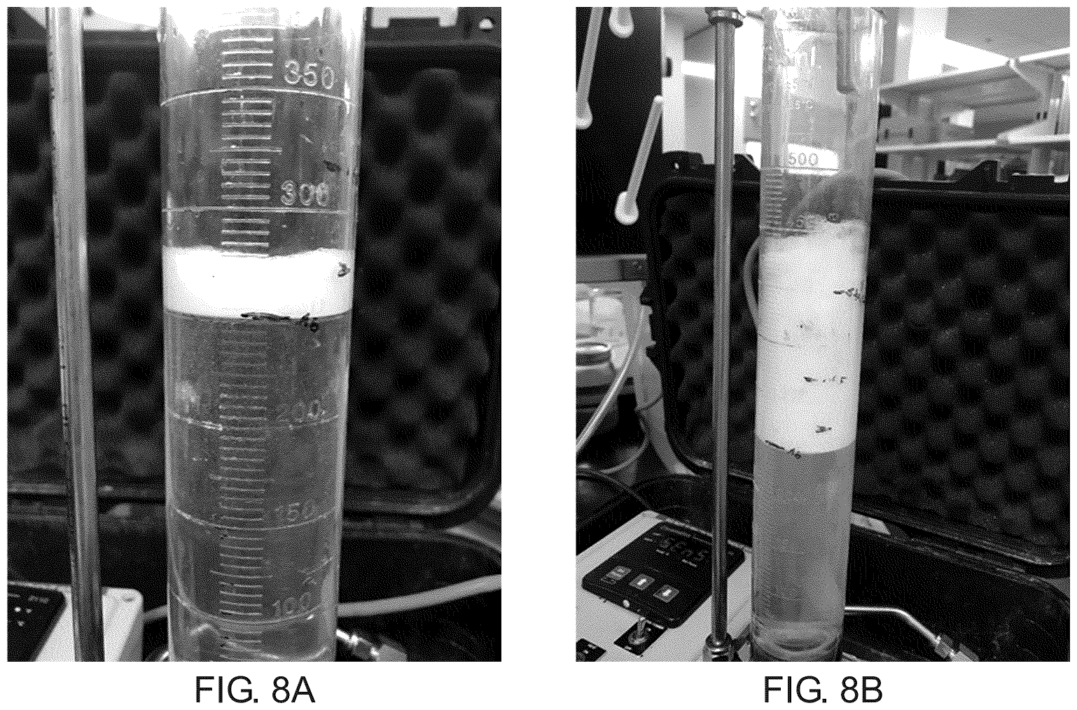

Moreover, the foam height of the reformulated Example 1 was not only reduced to a lower level than that of the Comparative Example 1, but the surfactant package that was introduced provided lower foam persistency. FIGS. 8A (Example 2 at 35° C. after 1 minute in the blender) and 8B (Comparative Example 1 solution at 35° C. after 1 minute in the blender) compare foam height of Example 1 with Comparative Example 1. As seen in FIGS. 7A and 7B, Example 1 exhibits lower foaming than Comparative Example 1.

For the high shear blender testing, the foam height increase over time was considered to be attributable to creep on the wall of the graduated cylinder. Example 5 showed similar or decreased foaming tendency compared to Comparative Example 1. As seen in Tables 12 and 13, Example 1 foam was less persistent than Comparative Example 1, as evidenced by the foam cell generator test where there was a lower overall amount of foam present in Example 1 when compared to Comparative Example 1.

A Cloud Point anti-foaming product was also tested. To accomplish this, the foam cell generator was operated continuously at 100% recirculation speed. The products were added to the respective 4% solution and recirculation was continued and then the foam height was measured while recirculating. Comparative Example 1 had an initial foam height of 80 mm and then when 200 ppm of Cloud Point product was added, the foam height was maintained at the same level of 80 mm. After cutting off the recirculation pump, foam persistence was evaluated over time. Comparative Example 1, with 200 ppm of added cloud point, had a much higher foam persistence than Example 1, as seen in FIGS. 8A (4% solution of Example 1 after 30 seconds of recirculation in the foam cell generator) and 8B (4% solution of Comparative Example 1 after 30 seconds of recirculation in the foam cell generator).

Example 1 was recirculated in the exact same fashion and also had a base foam height of 80 mm. When recirculation was stopped, Example 1 solution foam began to dissipate quickly with no other added products. Upon adding 200 ppm of anti-foaming product, the foam height was immediately reduced to 55-60 mm during constant recirculation. After cutting off the recirculation, the foam height was immediately reduced to under 5 mm in 15 seconds.

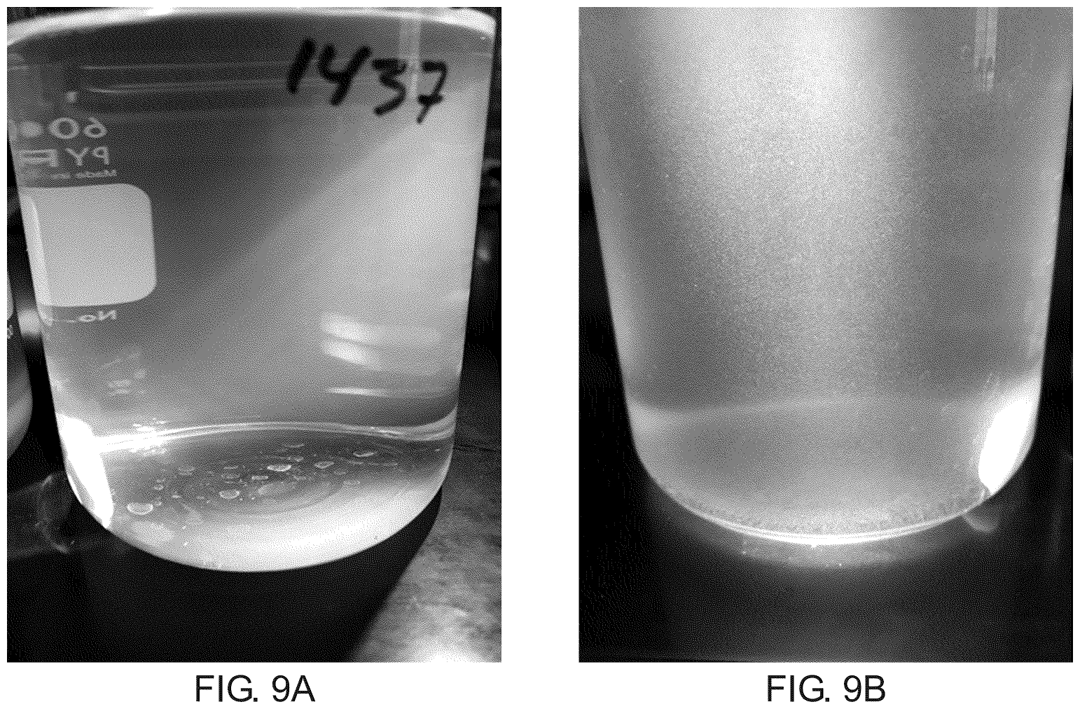

These results suggest that Example 1 was more stable than Comparative Example 1. This is further evidenced by FIGS. 9A and 9B which show Example 1 at 35° C. having no visible particles (FIG. 9A), and Comparative Example 1 at 35° C. having visible particles (FIG. 9B).

These results show that the treatment compositions according to disclosed embodiments exhibit superior properties associated with improved foaming, corrosion inhibition, and surface tension compared to conventional products.

It will be appreciated that the above-disclosed features and functions, or alternatives thereof, may be desirably combined into different systems or methods. Also, various alternatives, modifications, variations or improvements may be subsequently made by those skilled in the art. As such, various changes may be made without departing from the spirit and scope of this disclosure.

What is claimed is:

1. A method for treating a metal surface in a surface preparation system, the method comprising:
providing a treatment composition comprising amine borate, an organic corrosion inhibitor, and at least one surfactant;
applying the treatment composition to the metal surface in the surface preparation system; and
forming a protective anti-corrosion film on the metal surface.

2. The method according to claim 1, wherein applying the treatment composition to the metal surface in the surface preparation system includes spraying the treatment composition on the metal surface.

3. The method according to claim 1, further comprising performing a de-scaling and cleaning process on the metal surface before or during applying the treatment composition to the metal surface in the surface preparation system.

4. The method according to claim 1, further comprising performing a de-scaling and cleaning process on the metal surface before applying the treatment composition to the metal surface in the surface preparation system.

5. The method according to claim 1, wherein the treatment composition excludes phosphates.

6. The method according to claim 1, wherein the organic corrosion inhibitor is at least one selected from the group consisting of TTA, BZT, HST, BuBZT, MBT, imidazoles, halogenated azoles and imidazolines, and amides.

7. The method according to claim 6, wherein the organic corrosion inhibitor is TTA.

8. The method according to claim 1, wherein the at least one surfactant includes ethylene oxide/propylene oxide block copolymer and ethoxylated propoxylated alcohol.

9. The method according to claim 1, wherein the amine borate is present in the treatment composition in aqueous solution in an amount in a range of 1 to 10,000 ppm.

10. The method according to claim 1, wherein the amine borate is present in the treatment composition neat in an amount in a range of 1 to 60 wt %.

11. The method according to claim 1, wherein the organic corrosion inhibitor is present in the treatment composition in aqueous solution in an amount in a range of 1 to 1,000 ppm.

12. The method according to claim 1, wherein the organic corrosion inhibitor is present in the treatment composition neat in an amount in a range of 0.01 to 20 wt %.

13. The method according to claim 1, wherein the at least one surfactant is present in the treatment composition in aqueous solution in an amount in a range of 1 to 1,000 ppm.

14. The method according to claim 1, wherein the at least one surfactant is present in the treatment composition neat in an amount in a range of 0.01 to 20 wt %.

15. The method according to claim 1, wherein the treatment composition further comprises an inorganic corrosion inhibitor that is a salt of at least one metal selected from the group consisting of Zn, Mo, Sn, W, Ce, La, and Al.

16. The method according to claim 15, wherein the inorganic corrosion inhibitor is a stannous salt.

17. The method according to claim 1, wherein the surfactant is an ethoxylate or propoxylate of a molecule which is not an alkylphenol.

18. The method according to claim 1, wherein the surfactant is an alkoxylated saturated alcohol.

19. The method according to claim 1, wherein the surface preparation system is a steel-making system and the metal surface is part of a hot-rolled steel strip.

20. The method according to claim 1, wherein a chloride content in the treatment composition is 500 ppm or less for neat.

21. The method according to claim 1, wherein a chloride content in the treatment composition is 30 ppm or less for 4% aqueous solution.

22. The method according to claim 1, wherein a sulfate content in the treatment composition is 500 ppm or less for neat.

23. The method according to claim 1, wherein a sulfate content in the treatment composition is 30 ppm or less for 4% aqueous solution.

24. The method according to claim 1, wherein a 4% aqueous solution of the treatment composition has a breakpoint in a range of 2 to 2.5% according to a cast iron chip corrosion test conducted according to ASTM D4627.

25. The method according to claim 1, wherein the treatment composition exhibits a foam height of 6 mm or less after 5 minutes according to a foam height test, the foam height test including preparing a 4% aqueous sample solution of the treatment composition using RO water to dilute, placing the sample solution into a 500 mL container and immersing the container in a hot water bath at 85° F., letting the sample sit until it comes to temperature, adding the sample solution to a high speed blender and blending for at least 1 minute, then pouring the sample solution into a 1 L graduated cylinder, and measuring foam height from a top of a foam to a meniscus of the sample solution in the graduated cylinder.

26. The method according to claim 1, wherein the treatment composition has a characteristic such that a 4% aqueous solution of the treatment composition at 35° C. exhibits less visible particles compared to a reference aqueous solution containing amine borate and a phosphate using a visible eye test.

27. A method for treating a metal surface in a surface preparation system, the method comprising:
providing a treatment composition comprising amine borate, an organic corrosion inhibitor, and at least one surfactant;
applying the treatment composition to the metal surface in the surface preparation system; and
forming a protective anti-corrosion film on the metal surface,
wherein the treatment composition excludes phosphates,
the organic corrosion inhibitor is at least one selected from the group consisting of TTA, BZT, HST, BuBZT, MBT, imidazoles, halogenated azoles and imidazolines, and amides, and
the surfactant is an ethoxylate or propoxylate of a molecule which is not an alkylphenol.

28. A treatment composition suitable to treat a metal surface in an industrial surface preparation process, the composition comprising:
amine borate in an amount in a range of 1 to 60 wt %;
an organic corrosion inhibitor in an amount in a range of 0.01 to 20 wt %; and
at least one surfactant in an amount in a range of 0.01 to 20 wt %;
wherein the treatment composition excludes phosphates.

29. The treatment composition according to claim 28, wherein the amine borate is present in the treatment composition in an amount in a range of 10 to 18 wt %.

30. The treatment composition according to claim 28, wherein the organic corrosion inhibitor is present in the treatment composition in an amount in a range of 0.07 to 1.8 wt %.

31. The treatment composition according to claim 28, wherein the at least one surfactant is present in the treatment composition in an amount in a range of 0.25 to 10 wt %.

32. The treatment composition according to claim 28, wherein the organic corrosion inhibitor includes TTA.

33. The treatment composition according to claim 28, wherein the at least one surfactant includes ethylene oxide/propylene oxide block copolymer and ethoxylated propoxylated alcohol.

34. The treatment composition according to claim 28, further comprising an inorganic corrosion inhibitor that is a salt of at least one metal selected from the group consisting of Zn, Mo, Sn, W, Ce, La, and Al.
